(19) United States
(12) Patent Application Publication
(10) Pub. No.: US 2014/0202797 A1
(43) Pub. Date: Jul. 24, 2014

(54) REDUCING OVER-TRACTION IN AN ELEVATOR

(71) Applicant: Inventio AG, Hergiswil (CH)

(72) Inventor: Roman Lenk, Hagendorn (CH)

(21) Appl. No.: 13/959,174

(22) PCT Filed: Sep. 27, 2012
(86) PCT No.: PCT/EP2012/069133

§ 371 Date: Aug. 5, 2013

(30) Foreign Application Priority Data
Sep. 30, 2011 (EP) 11183576.5

(51) Int. Cl. B66B 5/08; B66B 5/00; B66B 5/12; B66B 11/00

(52) U.S. Cl. CPC B66B 5/08; B66B 11/008; B66B 5/0031; B66B 5/12
USPC 187/254; 187/349

(57) ABSTRACT

An elevator installation has a car, a counterweight, a traction device interconnecting the car and the counterweight, a motor and a traction sheave engaging the traction device. The elevator installation is monitored for over-traction and an air cushion is created between the traction sheave and the traction device when over-traction is detected.

### FIELD

The invention relates to operation of an elevator traction drive in an elevator installation.

### BACKGROUND

In an elevator installation, an elevator car and a counterweight are conventionally supported on and interconnected by traction means. The traction means is driven through engagement with a motor-driven traction sheave to move the car and counterweight in opposing directions along the elevator hoistway. The drive unit, consisting of the motor, an associated brake and the traction sheave, is normally located in the upper end of the elevator hoistway or alternatively in a machine room directly above the hoistway.

Traditionally, steel cables have been used as traction means. More recently, synthetic cables and belt-like traction means comprising steel or aramid cords of relatively small diameter coated in a synthetic material have been developed. An important aspect of these synthetic traction means is the significant increase in the coefficient of friction they exhibit through engagement with the traction sheave as compared to the traditional steel cables. This can give rise to a situation called over-traction. Due to this increase in relative coefficient of friction, when the brake is applied in an emergency stop for an elevator employing synthetic traction means there is an significant increase in the deceleration of the car which severely degrades passenger comfort and could even result in injury to passengers.

Publications WO-A1-2011/069773, GB-A-2153465, U.S. Pat. No. 5,323,878 and U.S. Pat. No. 5,244,060 all describe methods of controlling the movement of an elevator car during an emergency stop wherein the brake is applied but the degree of the brake force or torque exerted by the brake is dependent on the load of the car. These methods help reduce deceleration of the elevator car during an emergency stop.

A further important consequence of over-traction is that if the counterweight becomes stuck along the hoistway, so that the section of the traction means between the traction sheave and the counterweight becomes slack, the drive may still be capable of moving the elevator car upwards. In a second converse situation, if the car becomes jammed while being lowered down the hoistway, resulting in slackening of the section of the traction means between the car and the traction sheave, the drive may still be capable of moving the counterweight upwards. Either situation presents a severe risk of injury to any passengers in the car because when the elevator controller eventually directs the drive unit to stop, the elevator car will drop back down the hoistway in the first situation whereas the counterweight will fall back and subsequently jerk the car upwards in the second situation.

US-A1-2008/0185232 describes an apparatus and method for solving the problems associated with the first situation described above. The drive unit has a motor unit and a deflecting unit. If the counterweight which is supported by the deflecting unit rests on a pit buffer for example, the deflecting unit is unloaded and is raised by means of a spring element of the monitoring device. A sensor of the monitoring device detects the movement of the deflecting unit and switches off the motor of the motor unit via a safety circuit.

The problems associated with second situation outlined above have conventionally been solved by monitoring the tension in the traction means on the car-side of the traction sheave with a slack rope contact such as described in US-A1-2007/0170009. Because of its complexity, the slack rope contact solution is expensive, time-consuming to install and must be individually tailored to the existing car or car frame during modernization of an existing installation. EP-M-2292546 describes an alternative method wherein the load of the car is monitored along its downward travel path and it is determined that the car has jammed if the monitored load of the car deviates outside a predetermined range. Accordingly, the elevator controller can automatically instruct the drive unit to commence an emergency stop such that the car can be stopped immediately and thereby minimize the risk of injury to passengers or damage to the car.

EP-A2-1764335 proposes another solution to over-traction wherein the running surface of the traction sheave, over which the traction means runs, is provided with a friction-reducing coating or subjected to a friction-reducing surface treatment.

### SUMMARY

An objective of the present invention is to provide an elevator drive that reduces the effects and stated disadvantages of over-traction. A further objective is to provide an elevator installation and an operating method in which the elevator car cannot be raised further by the traction means if the counterweight becomes jammed along its travel path particularly when it strikes an associated buffer.

Accordingly, the invention provides a method of operating an elevator installation having a car, a counterweight, traction means interconnecting the car and the counterweight, a motor and a traction sheave engaging the traction means, comprising the steps of monitoring the elevator installation for over-traction, creating an air cushion between the traction sheave and the traction means when over-traction is detected, and regulating flow to the air cushion. The creation of an air-cushion between the traction sheave and the traction means reduces both the engagement and the traction capability therebetween resulting in a reduction in the effects of over-traction and regulating the flow to the air cushion ensures that the car can remain stationary so as to reduce jerk on the car and risk of injury to passengers or damage to the car.

Over-traction can be monitored by detecting whether the car or the counterweight engages with a buffer.

Alternatively, the step of monitoring the elevator installation for over-traction can comprises detecting whether the car or the counterweight moves into a predetermined section of a hoistway of the elevator installation.

In a further alternative, over-traction can be monitored by detecting a predetermined unloading of the motor and traction sheave.

Over-traction can also be monitored by detecting a reduction in the tension in a portion of the tension means.

Preferably, the position of the car is monitored so as to provide a control signal to regulate flow to the air cushion. Accordingly, once over-traction has been detected, the flow to air cushion can be changed to ensure that the car remains in a stationary position.

The invention also provides an elevator installation comprising a car, a counterweight, traction means interconnecting the car and the counterweight, a motor, a traction sheave having an engagement surface for engaging the traction means, a position sensor to determine the position of the car, at least one sensor to detect over-traction, and a pneumatic circuit connecting the engagement surface to a source of pressurized gas. If over-traction is detected by the sensor, pressurized gas can be directed to the engagement surface to create an air-cushion between the traction sheave and the traction means. This reduces both the engagement and the traction capability therebetween resulting in a reduction in the effects of over-traction.

Preferably, the traction sheave contains a cavity and a plurality of holes extending between the cavity and the engagement surface.

Preferably, the pneumatic circuit contains a pneumatic valve to regulate the flow of pressurized gas through the circuit. The pneumatic valve can be actuated by the sensor.

Furthermore, the pneumatic circuit may contain a flow regulator. Accordingly, the degree of flow of pressurized gas to the air cushion can be controlled. Preferably, the flow regulator is connected to the position sensor so that the degree of flow is dependent on the position of the car so as to ensure that the car remains stationary.

The sensor can be mounted on a buffer to detect whether the car or counterweight has collided with its respective buffer. Alternatively, the sensor can be mounted within the hoistway to detect whether the car or the counterweight moves into a predetermined section of a hoistway.

In one example, the motor is mounted on resilient means. In this case, the sensor can detect displacement of the motor. Accordingly, when either the car or the counterweight becomes jammed when moving down the hoistway resulting in an over traction situation, the motor becomes unloaded, the resilient means relax and the motor is thereby displaced. This displacement is detected by the sensor.

### DESCRIPTION OF THE DRAWINGS

The invention is herein described by way of specific examples with reference to the accompanying drawings of which:

FIG. 1 is a schematic of an elevator installation;

FIG. 2 is an exploded perspective view of a traction sheave for use in the elevator installation of FIG. 1;

FIG. 3 is a transverse view of an elevator drive incorporating the traction sheave of FIG. 2 operating under normal conditions for use in the elevator installation of FIG. 1;

FIG. 4 is a transverse view of the elevator drive of FIG. 3 when over-traction has been detected;

FIG. 5 is a transverse view of an alternative elevator drive arrangement incorporating the traction sheave of FIG. 2 operating under normal conditions for use in the elevator installation of FIG. 1; and

FIG. 6 is a transverse view of the elevator drive of FIG. 5 when over-traction has been detected.

### DETAILED DESCRIPTION

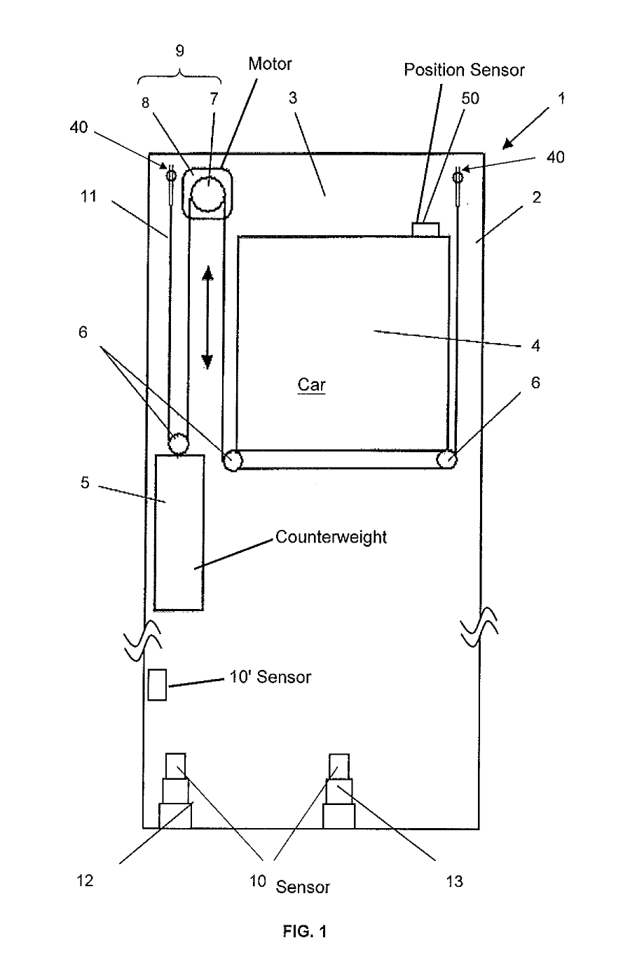

An elevator installation 1 according to the invention is shown in FIG. 1. The installation 1 is generally defined by a hoistway 3 bound by walls 2 within a building wherein a counterweight 5 and car 4 are movable in opposing directions along guide rails (not shown). A position sensor 50 is mounted on the car 4 to determine its position within the hoistway 3. Buffers 12, 13 are mounted in a pit of the hoistway 3 underneath the counterweight 5 and car 4, respectively. Sensors 10 are provided on each of the buffers to determine whether the car 4 or counterweight 5 collides with its respective buffer 12, 13. Suitable traction means 11 supports and interconnects the counterweight 5 and the car 4. The traction means or device 11 is fastened at either end to termination devices 40 mounted in the upper region of the hoistway 3. The traction means 11 extends from one termination device 40 to a deflection pulley 6 mounted on top of the counterweight 5, over a traction sheave 7, under the car 4 via deflection pulleys 6 and is fastened at the other end in the other termination device 40. Naturally, the skilled person will easily appreciate other elevator roping arrangements are equally possible.

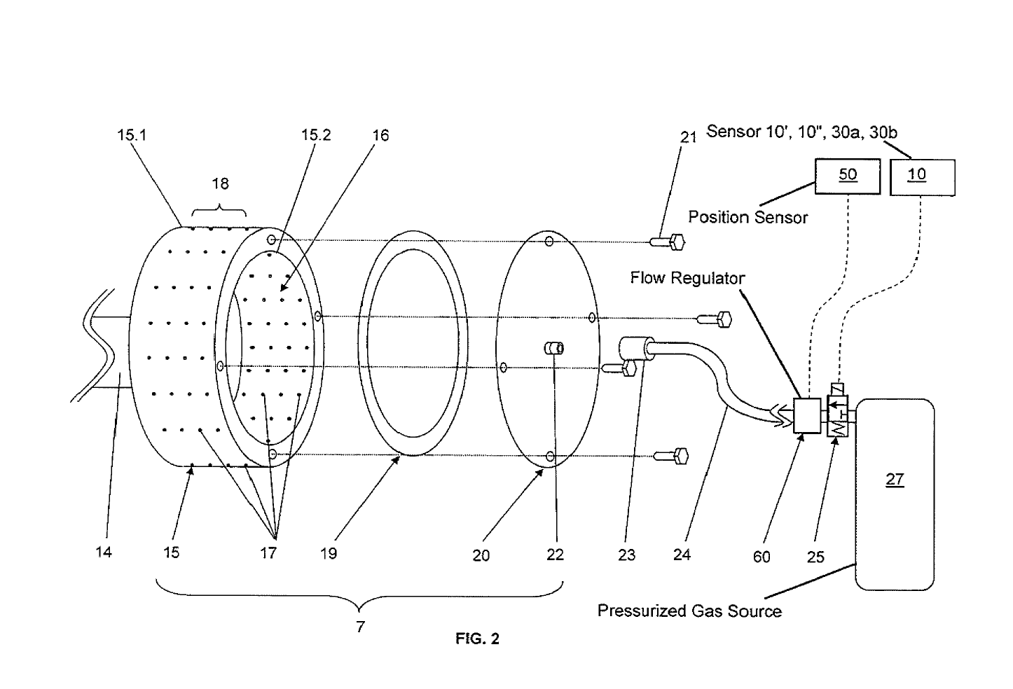

The traction sheave 7 is driven by a motor 8 which together form the drive 9 of the elevator 1. As shown specifically in the exploded view of FIG. 2, the traction sheave 7 is implemented as a cylindrical body 15 having a closed axial end connected to a shaft 14 of the motor 8 for concurrent rotation therewith. At the opposing axial end, the cylindrical sheave body 15 is open to define a cavity 16 bound by a radially inner, cylindrical surface 15.2. The traction means 11 engages with an engagement surface 18 on a radially outer, cylindrical surface 15.1 of the sheave body 15. A plurality of holes 17 extend radially between the inner surface 15.2 and the outer surface 15.1 of the sheave body 15. The cavity 16 is hermetically sealed by a gasket 19 positioned between the sheave body 15 and a closing plate 20 which is fastened by bolts 21 to the sheave body 15.

A pneumatic circuit is connected to the cavity 16 by a nozzle 22 mounted on the closing plate 20. The pneumatic circuit comprises a female connector 23 which hermetically engages with the nozzle 22 to permit relative rotation therebetween and further includes tubing 24 leading from the female connector 23 through a flow regulator 60 to a pneumatic valve 25 which in turn is connected to a source of pressurized gas 27. The pneumatic valve 25 is spring-biased to a non-conducting state (as shown) but can be activated into a conducting state by a solenoid actuator 26. The solenoid actuator 26 is controlled by signals sent from the sensors 10. The flow regulator 60 is controlled by signals sent from the position sensor 50 mounted on the car.

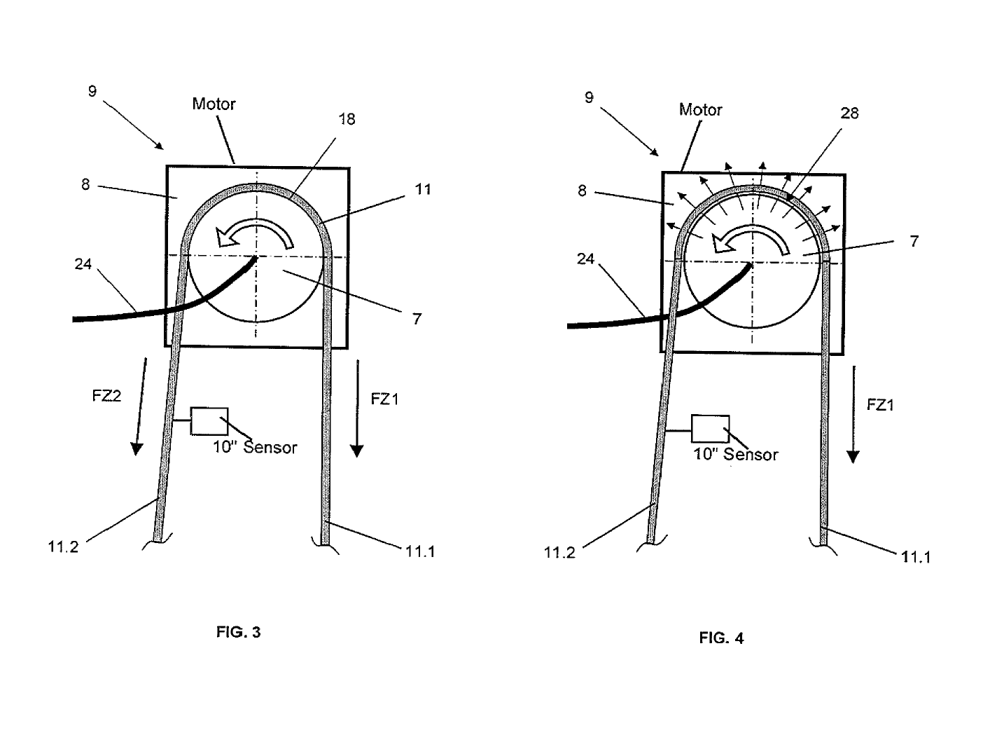

As shown in FIG. 3, a first portion 11.1 of the tension means 11 spanning the traction sheave 7 and the deflection pulleys 6 mounted under the elevator car 4 is under a first tension FZ1. Likewise on the other side of the sheave 7, the portion 11.2 of the traction means 11 spanning between the sheave 7 and the deflection pulley 6 mounted on the counterweight 5 experiences a second tension FZ2.

In normal operation of the elevator installation 1, the motor 8 will rotate the traction sheave 7 to drive the interconnected car 4 and counterweight 5 via the tension member 11 to enable transportation of passengers and goods in the car 4 between floors within the building. Since neither the car 4 nor the counterweight 5 engages with its associated buffer 12, 13 during such normal operation, the sensors 10 remain inactive and accordingly, the pneumatic valve 25 maintains a non-conducting state.

If however an over-traction situation is detected as depicted in FIG. 4, in the present example the counterweight 5 engaging its buffer 12 in the pit of the hoistway 3 and thereby triggering the sensor 10, the pneumatic valve 25 is activated into a conducting state by the solenoid actuator 26 and pressurized gas flows through the pneumatic circuit into the internal cavity 16 of the traction sheave body 15, through the holes 17 extending radially through the sheave body 15 and out from the radially outer, cylindrical surface 15.2 of the sheave body 15. This flow of pressurized gas creates an air-cushion 28 between the engagement surface 18 on the outer surface 15.2 of the traction sheave 7 and the traction means 11 reducing both the engagement and the traction capability therebetween. The degree to which the traction capability is reduced is determined by the flow regulator 60 which is controlled by the signals received from the car position sensor 50. Initially, as the counterweight 5 engages its buffer 12 in the pit of the hoistway 3, maximum flow of pressurized gas will be required through the regulator 60 to ensure that the position of the car 4 as measured by position sensor 50 remains constant or stationary. As the effects of over-traction subsequently subside, the flow through the regulator 60 can be reduced. The flow is thereby regulated to maintain the car in a substantially stationary position.

Instead of providing sensors 10 on each of the buffers to determine whether the car 4 or counterweight 5 collide with its respective buffer 12, 13, one or more sensors 10′ can be mounted within the hoistway 3, as shown in FIG. 1, to detect whether the car 4 or counterweight 5 moves into a predetermined section of a hoistway 3.

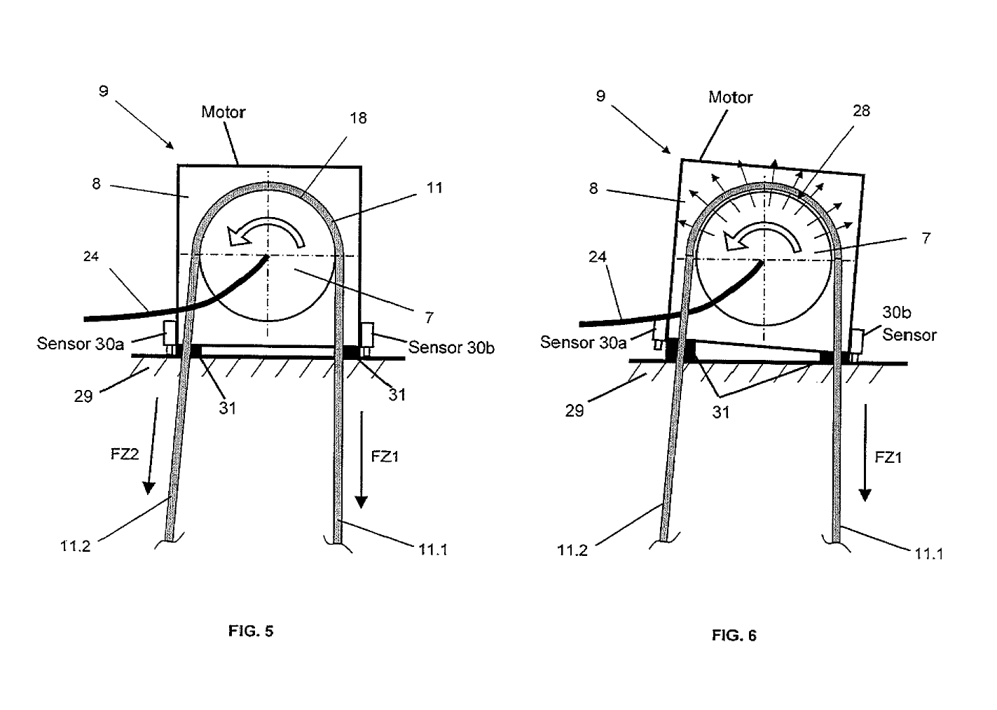

The skilled person will readily appreciate that instead of using buffer sensors 10 to detect over-traction, alternative means are available. In an alternative arrangement as shown in FIGS. 5 and 6, displacement sensors 30a, 30b, such as those used in US-A1-2008/0185232, are arranged to detect over-traction. In this example the elevator drive 9 of FIG. 2 is mounted via resilient means 31 to a support 29 within the hoistway 3. Again, as in the previous example, a first portion 11.1 of the tension means 11 spanning the traction sheave 7 and the deflection pulleys 6 mounted under the elevator car 4 is under a first tension FZ1. Likewise on the other side of the sheave 7, the portion 11.2 of the traction means 11 spanning between the sheave 7 and the deflection pulley 6 mounted on the counterweight 5 experiences a second tension FZ2.

In normal operation, as shown in FIG. 5, the downward tensions FZ1 and FZ2 in the traction means 11 cause the drive 9 to compress the resilient means 31. If, however, an over-traction situation is detected, such as the counterweight 5 becoming jammed while moving down the hoistway 3 or if it strikes its buffer 12, the second tension FZ2 is substantially relieved and consequently the load of the drive 9 on its resilient mounting means 31 is significantly reduced as shown in FIG. 6 and the drive 9 is raised. Displacement sensors 30a, 30b are arranged at opposing sides of the motor 8 to detect this movement of the drive 9. In the example as shown, sensor 30a triggers the solenoid actuator 26 so that the pneumatic valve 25 is activated into a conducting state and pressurized gas flows through the pneumatic circuit into the internal cavity 16 of the traction sheave body 15, through the holes 17 extending radially through the sheave body 15 and out from the radially outer, cylindrical surface 15.2 of the sheave body 15. This flow of pressurized gas creates an air-cushion 28 between the engagement surface 18 on the outer surface 15.2 of the traction sheave 7 and the traction means 11 reducing both the engagement and the traction capability therebetween. The degree to which the traction capability is reduced is determined by the flow regulator 60 which is controlled by the signals received from the car position sensor 50. Initially, as the counterweight 5 engages its buffer 12 in the pit of the hoistway 3, maximum flow of pressurized gas will be required through the regulator 60 to ensure that the position of the car 4 as measured by position sensor 50 remains constant or stationary. As the effects of over-traction subsequently subside, the flow through the regulator 60 can be reduced. The flow is thereby regulated to maintain the car in a substantially stationary position.

Although the specific example shown in FIGS. 5 and 6 depicts the counterweight 5 becoming jammed while moving down the hoistway 3 or striking its buffer 12, the person skilled in the art will easily appreciate that the same arrangement can be used to detect over-traction due to the car 4 becoming jammed while moving down the hoistway 3 or striking its buffer 13.

Another alternative for detecting over-traction is to monitor at least one of the tensions FZ1 and FZ2 in the first portion 11.1 and second portion 11.2 of the tension means 11 with a slack rope contact such as described in US-A1-2007/0170009. When the contact 10″ (FIGS. 3 and 4) detects that a portion of the tension means 11 has become slack it activates the solenoid actuator 26 to create an air-cushion 28 between the traction sheave 7 and the traction means 11 as described previously above.

Although the examples have been described as overcoming the problems associated with over-traction when the counterweight or car becomes stuck while moving downwards in the hoistway, it will be apparent to those skilled in the art that the invention can be easily adopted to alleviate the previously described problems associated with over-traction during emergency stops.

The present invention has been developed, in particular, for use in conjunction with synthetic traction means, but it can equally be applied to any elevator to reduce problems associated with over-traction and thereby improve passenger comfort.

In accordance with the provisions of the patent statutes, the present invention has been described in what is considered to represent its preferred embodiment. However, it should be noted that the invention can be practiced otherwise than as specifically illustrated and described without departing from its spirit or scope.

1. A method of operating an elevator installation having a car, a counterweight, a traction means interconnecting the car and the counterweight, a motor and a traction sheave engaging the traction means, comprising the steps of:
monitoring the elevator installation for over-traction between the traction means and the traction sheave;
creating an air cushion between the traction sheave and the traction means when over-traction is detected; and
regulating air flow to the air cushion.

2. The method according to claim 1 wherein the step of monitoring the elevator installation for over-traction comprises detecting whether the car or the counterweight engages with a buffer.

3. The method according to claim 1 wherein the step of monitoring the elevator installation for over-traction comprises detecting whether the car or the counterweight moves into a predetermined section of a hoistway of the elevator installation.

4. The method according to claim 1 wherein the step of monitoring the elevator installation for over-traction comprises detecting a predetermined unloading of the motor and traction sheave.

5. The method according to claim 1 wherein the step of monitoring the elevator installation for over-traction comprises detecting a reduction in the tension in a portion of the tension means.

6. The method according to claim 1 wherein the step of regulating flow to the air cushion is controlled by monitoring a position of the car in a hoistway to ensure that the car does not move.

7. An elevator installation comprising a car, a counterweight, a traction means interconnecting the car and the counterweight, a motor, a traction sheave having an engagement surface for engaging the traction means, a position sensor to determine the position of the car, at least one sensor to detect over-traction, and a pneumatic circuit connecting the engagement surface to a source of pressurized gas, the pneumatic circuit being responsive to the position sensor and the at least one sensor for creating an air cushion between the engagement surface and the traction means.

8. The elevator installation according to claim 7 wherein the traction sheave contains a cavity and a plurality of holes extending between the cavity and the engagement surface.

9. The elevator installation according to claim 7 wherein the pneumatic circuit contains a pneumatic valve connected between the source of pressurized gas and the engagement surface.

10. The elevator installation according to claim 9 wherein the pneumatic valve is actuatable by the at least one sensor.

11. The elevator installation according to claim 7, wherein the pneumatic circuit contains a flow regulator connected between the source of pressurized gas and the engagement surface.

12. The elevator installation according to claim 11 wherein the flow regulator is connected to the position sensor.

13. The elevator installation according to claim 7, wherein the at least one sensor is mounted on a buffer.

14. The elevator installation according to claim 7, wherein the at least one sensor or the counterweight moves into a predetermined section of a hoistway.

15. The elevator installation according to any of claim 7, wherein the motor is mounted on resilient means.

16. The elevator installation according to claim 14, wherein the at least one sensor detects displacement of the motor.
